(19) United States
(12) Patent Application Publication
(10) Pub. No.: US 2010/0223075 A1
(43) Pub. Date: Sep. 2, 2010

(54) System and method for integrating the health club and health insurance industries to reduce costs by providing financial incentives for health club members and health insured to improve and maintain their health

(76) Inventors: Jerry L. Sparks, Houston, TX (US); Shane Allbee, Houston, TX (US); Richard Beech, Houston, TX (US); Dirk Hunter, Houston, TX (US)

Correspondence Address: DAVID W. ALEXANDER, 1989 Kingston Cove, League City, TX, 77573, US

(21) Appl. No.: 12/799,833

(22) Filed: May 3, 2010

(51) Int. Cl. G06Q 50/00; G06Q 40/00; G06Q 30/00; G06Q 10/00

(52) U.S. Cl. 705/3; 705/4; 705/2

(57) ABSTRACT

The invention described herein is a system and method whereby health club membership and its attendant health-promoting advantages is integrated with the health insurance industry to create a whole which reduces costs for both and provides financial incentives for individuals to improve and maintain their health. Individuals or employees participating in the integrated health club/health insurance program are motivated to improve their health by the rewards of one or more of subsidized health club dues or reduced health insurance premiums or deductibles for themselves or their employers. The invention achieves this goal in a way that is sustainable and profitable for all involved—individual, health club owner, employer, and health insurance provider.

### CROSS-REFERENCES RELATED APPLICATIONS

Not applicable.

### STATEMENT REGARDING FEDERALLY SPONSORED RESEARCH OR DEVELOPMENT

Not applicable.

### MICROFICHE APPENDIX

Not applicable.

### BACKGROUND OF THE INVENTION

(1) Field of the Invention

The present invention relates to a system and method to improve the health of individuals through health club membership integrated with health insurance benefits available to them and their employers at reduced insurance deductibles and/or premiums and health club dues. More specifically, the invention described herein transforms individuals into healthier persons by promoting more healthful lifestyles and exercise habits reinforced by the incentives of reduced or subsidized health club dues and simultaneous reduced health insurance deductibles and/or premiums. The invention transforms society into a group of more healthful individuals by creating financial incentives for individuals or employer's employees to seek out and maintain health club membership. The invention further transforms the heretofore separate health and fitness and health insurance industries into a cohesive unit that ultimately results in healthier individuals and reduced health insurance deductibles and/or premiums and health club dues.

(2) Background of the Invention

Approximately 45 million Americans are currently without health insurance. Obesity, diabetes, hypertension, depression, anxiety and other related adverse health conditions are increasing among the population of the United States. These health conditions are increasing the cost of treatment and health insurance for all, including the healthy.

The bulk of health insurance costs are borne by employers as a benefit to their employees. As the population of the United States ages, sedentary lifestyles become more prevalent, and health care technology becomes more complex and expensive, the system of employer-subsidized healthcare is crippling the competitiveness of American businesses. Further, as the economy waxes and wanes, many people find themselves without health insurance through the loss of employment.

The governments of most developed countries provide subsidized healthcare to its citizens. The United States is contemplating universal healthcare or expanding Medicare and Medicaid to cover more Americans. However, with the current poor health of a large number of Americans the cost will be almost beyond comprehension. Over the next two decades the average American household's health care spending, including the portion of its taxes that pays for Medicare and Medicaid, will almost double as a percentage of average household income. It is imperative that health care costs be better managed to avoid the inevitable financial burden that will occur if we progress along the path of the past.

Even in a government-subsidized health care system, employers will bear some financial burden. Surcharges may be assessed against the employer who does not arrange for a pre-tax payroll deduction system for health insurance and has employees who receive care that is paid from an uncompensated care pool.

The unemployed typically cannot afford health insurance or health club dues and many employers do not provide it as a benefit. These individuals sometimes have poor health, usually from lifestyle decisions or chronic mental or physical ailments. Due to lack of health insurance coverage, uninsured individuals commonly utilize emergency rooms as a source of primary care. Many state supported hospitals are required to provide care even if a patient cannot pay for it. As a result, hospitals faced unpaid bills and mounting expenses to care for the uninsured. The uninsured and the chronically unhealthy conspire to raise health insurance costs and premiums for all.

In the current and future system of health care, individuals and employers will always share the cost. Employers strive to manage the health of their employees, not only to save money, but to improve their health. Individuals seek to find affordable health insurance with a premium set by a pool of insured with a similar lifestyle and overall healthy profile. Unfortunately, for individuals and employers there is currently little that either can do to reduce their health insurance deductibles and/or premiums or health club dues even if they or their employees maintain healthy lifestyles.

Currently, health insurance premiums are based on the treatment costs for many, both the healthy and unhealthy, averaged over a treated population. Typically, treatment cost is based on treating symptoms of pain and/or dysfunction only after illness has occurred. Thus, the cost is determined and paid after the illness develops and treatment occurs, which results in a costly, after-the-illness model for benefit delivery. Insurers have failed to recognize that the number of treatment occurrences can be decreased if their insured were provided incentives to perform health-promoting measures that would improve their health; such as lifestyle changes and regular exercise.

It is well known that healthier employees spend fewer days away from work due to illness. Less absenteeism can annually save companies thousands of dollars per employee due to reduced down time, costs of rework and impaired goodwill, and the premium costs for temporary replacements. Employer sponsored and health club well-ness programs contribute to employee health. They not only improve employees' physical well-being, they also alleviate depression and help employees manage their time and stress levels, which contribute to productivity loss. It has been shown that employees participating in well-ness programs take as much as 70% fewer sick days than those opting out of such program.

It is generally accepted that preventable illness makes up about 70% of all health care claims. Many of these claims are linked to poor nutrition and/or health habits, which could be corrected through implementation of health promotion programs. Besides good nutrition and healthy lifestyle decisions, regular exercise is the most vital component to achieving overall good mental and physical health. Major research findings on the health benefits of physical activity have found: (1) regular physical activity reduces the risk of many adverse health outcomes; (2) some physical activity is better than none; (3) for most health outcomes, additional benefits occur as the amount of physical activity increases through higher intensity, greater frequency, and for longer duration; (4) most health benefits occur with at least 150 minutes per week of moderate-intensity physical activity and benefits accrue with more physical activity; (5) both aerobic and muscle-strengthening physical activity are beneficial; (6) health benefits occur for all ages, racial and ethnic groups; (7) the health benefits of physical activity occur for people with disabilities; and (8) the benefits of physical activity far outweigh the possibility of adverse outcomes.

There are recommended exercise programs for people of all ages of and levels of physical capability. It is well known that for every age group and capability one of the best places to exercise is at a health club. The health club provides facilities for year-round exercise regardless of weather, equipment to vary the program, professional staff to monitor safety and progress, and groups of like-minded individuals for inter-personal support and encouragement.

(3) Description of the Related Art Including Information Disclosed Under 37 C.F.R. 1.97 and 1.98

Although U.S. and foreign patents or published patent applications are known which disclose various systems and methods to improve human health, none of them disclose health club membership integrated with health insurance providers to provide an incentive for individuals and employees to maintain their fitness through lower health insurance premiums, deductibles and/or health club dues for the individual or the employer.

A system and method for monitoring individual efforts in maintaining health, which is reflected in his insurance premium, is described in Japanese Patent No. 2002263071. The invention allows a person to improve his health by tracking the number of times the person utilizes a health club or has a physical examination. However, recording the number of times a person attends a health club does not assess whether a person has performed any exercise activity or improved his health. Although number of health club visits and physical examinations are reported to the insurance provider there is no disclosure that the health insurance premiums and/or health club dues are reduced based on fitness level. Further, no system or method is disclosed to confirm that the number of health club visits are by the individual reporting to the insurance provider. It is not inconceivable that a member, in order to receive the insurance premium discount based on number of health club visits, would get another individual to impersonate him to create a fraudulent health club attendance record.

A device and method of monitoring health and discounting insurance premiums is disclosed in Ando, Masahiro, et al., U.S. Patent Application No. 2002/0013717. This invention reveals a wearable exercise monitor, such as a pedometer, with means to accurately record exercise performed by an insured individual and to generate data needed to calculate his insurance premium. The exercise monitor contains functions to verify the wearer's identity, confirm that he is actually wearing the monitor, and to allow the user to self-report his encrypted exercise data to insurance providers. The device can be very intrusive and distracting during exercise activities. Further, the mere monitoring and reporting of exercise activity is insufficient to provide the information necessary to properly group individuals for reduced health insurance premiums or subsidized health club dues.

Rooks, U.S. Patent Application No. 2004/0010420, discloses a method and system which uses scientifically-based algorithms and fitness equipment to assess a person's health, fitness and functional status. The system and method is used to develop an individualized exercise program to address the individual's specific health and fitness needs. The invention monitors exercise program progress, continuously adjusts exercise program, measures changes in health, fitness and functional status, and reports exercise participation and changes in health, fitness and functional status to the participant, his health care and health insurance provider. Rooks fails to disclose the health insurance providers use of the health and fitness information to create preferred risk groups with similar health profiles and therefore entitled to a particular health insurance premium or subsidized health club dues.

A system and method for evaluating insurance member activity and pricing insurance products is disclosed in Sirmans, Jr., U.S. Patent Application No. 2005/0102172. Sirmans relates to systems and methods for evaluating and establishing pricing of health insurance based on insured member compliance to health-promoting measures. Member participation in health-promoting activities are monitored and used to establish an incentive, such as reduction in insurance premiums, for that member. Exercise or activity monitors are worn by members to verify their identity and to record compliance in performing health-promoting measures. All health-related information, including physical examination results and recorded participation in health-promoting measures, are used to determine appropriate incentives to be rewarded. Like Rooks, Sirmans fails to disclose the health insurance providers use of the health and fitness information to create preferred risk groups with similar health profiles and therefore entitled to a particular health insurance premium or subsidized health club dues.

Minturn, U.S. Pat. No. 5,692,555, discloses a method and system for scientifically tracking and correlating a person's well-ness, optimal health, fitness, and risks quantification, interpretation, via a series of output reports and summary and a graduated numerical scales ranking based on a 10-Point Scientific Well-ness Scaling and Categories. The output report shows how the well-ness, optimal health, fitness and risk rating of the participant compares with optimal well-ness rating and ranking levels identified as excellent, good, average, poor, or dangerous. The invention further discloses a health insurance premium incentive feature wherein the premiums and deductibles are adjusted based upon the unique Insurability Ranking Factors which are cross-correlated to the actual and weighted scores on each of the 10-Point Scientific Well-ness Scales and Categories. Minturn fails to disclose the iterative process whereby the health insurance provider assesses the health profiles of its insured to create preferred risk categories which the determine the health insurance deductibles and premiums of its members.

Other insurance savings schemes have been proposed in which members claim benefits at a lower rate than normal and/or can accrue funds in a savings account. These schemes, however, do not provide an incentive for members to maintain healthy lifestyles nor do they include a means for accurately monitoring an individual's compliance with requisite exercise and health activities for maintaining health. Further, they do not disclose the integration of health and fitness information maintained and tracked by the health club and being regularly passed to health insurance providers who use the information to create new groups with similar risk profiles which in turn benefit the health club members by reduced health insurance deductibles or premiums and subsidized health club dues.

### BRIEF SUMMARY OF THE INVENTION

The invention described herein is a system and method whereby health club membership and its attendant health-promoting advantages are integrated with health insurance providers to create a whole which is heretofore neither anticipated by the relevant prior art nor obvious to those skilled in such arts. Individuals or employees of employers participating in the integrated health club/health insurance program are motivated to improve their own health by the rewards of one or more of subsidized health club dues or reduced health insurance deductibles and/or premiums for themselves or their employers. The invention achieves this goal in a way that is sustainable and profitable for all involved—individual, employer, health club owner, and health insurance provider.

The healthier population, regardless of age, exercises regularly, watches their diet and has periodic health examinations. In spite of these favorable traits, the healthier population is still grouped with those with less healthy lifestyles for health insurance purposes. The healthy and unhealthy typically pay the same premium for health insurance. This is because health insurance companies base their available deductibles and premiums on factors which are easily verifiable; such as, age, sex, smoking history, family health history and number of dependents. In the workplace, employers face the same dilemma. Regardless of an employers attention to the mental and physical fitness and lifestyles of its employees, its group health insurance premiums are largely determined by the simple factors of age, sex, smoking history, family health history and number of dependents of its employees. In sum, the individual or employer cannot obtain a credit for that individual's or employee's healthful lifestyle. This invention remedies those problems.

In the preferred embodiment of the invention, a health, well-ness and insurance association (“HWIA”) is formed. The HWIA integrates the functions of a health club, which typically provides facilities and equipment for exercise and other well-ness programs, and a health insurance provider. The HWIA enters into oral or written agreements with individuals and/or employers on behalf of their employees to provide health insurance and make available to participants the facilities, equipment and well-ness benefits of health clubs. The HWIA also enters into agreements with one or more health clubs, who make their facilities, equipment and service benefits available to the individuals and employees of employers who also have made agreements with the HWIA.

In another embodiment of the invention, a health and well-ness association (“HWA”) is formed. The HWA is similar to the HWIA, but does not provide health insurance in its own name to its individual and employer members. The HWA enters into oral or written agreements with individuals and/or employers on behalf of their employees to provide the facilities, equipment and well-ness benefits of the health club, while simultaneously offering the individual and employer access to one or more affiliated health insurance providers. The HWA enters into oral or written agreements with one or more health insurance providers. The agreements between the HWA and the one or more health insurance providers provide that the HWA will promote healthy lifestyles for and monitor the health of those individuals and employer's employees who are members of the association and assist the individuals and employers in obtaining health insurance through one or more of the affiliated health insurance providers. The HWA also enters into agreements with various health clubs, who make their facilities, equipment and service benefits available to the individuals and employees of employers who also have made agreements with the HWA.

In still another embodiment, a health club is formed. The health club provides facilities, equipment for exercise and other well-ness programs to its members. The health club enters into oral or written agreements with individuals and/or employers on behalf of their employees to provide the facilities, equipment and well-ness benefits of the health club, while simultaneously offering the individual and employer access to various health insurance providers. The health club enters into oral or written agreements with one or more health insurance providers. The agreements between the health club and the one or more health insurance providers provide that the health club will promote healthy lifestyles for and monitor the health of those individuals and employer's employees who are members of the health club and assist the member or employer in obtaining health insurance through one of the affiliated health insurance providers.

The embodiments of the invention disclosed herein contemplate that a number of group health insurance plans are available to employers. Group health insurance plans are similar in form to individual health insurance plans. The primary differences are the conditions under which a person may apply and the requirements for acceptance. Before applying through a group, an employee—including his or her spouse and dependents—may have to satisfy the employer's waiting periods and employment prerequisites of the group. Once an application can be made the conditions for acceptance into the group health insurance plan are usually less strict than for an individual. The embodiments of the invention are also cognizant of the fact that protections under the law are available for members of group health insurance policies which may not be available to individuals.

The invention disclosed herein also contemplates that an employer providing health insurance for his or her employees may select from any number of funding methods. The three most common methods of funding a group health insurance plan are the fully-funded plan, partially self-funded plan, and the fully self-funded plan. The fully-funded plan is the most common form of funding group health insurance. Here, the premium for the employer is fixed and all medical costs are paid for by either the insurance company or the insured. In the partially self-funded plan, the employer sets aside funds for a portion of his predictable claims while protecting the group against unpredictable catastrophic claims, through the purchase of group health insurance. In the fully self-funded plan, the employer pays all of the claims. If the employer believes a claim may exceed his or her ability to pay, he may purchase reinsurance from an insurance company.

The invention disclosed herein also contemplates that an employer has a number of funding options for group health insurance. The typical options are: the traditional indemnity or fee-for-service plan; the Preferred Provider Organization plan (“PPO”); the Point-of-Service plan (“POS”); and the Health Maintenance Organization plan (“HMO”). In the traditional indemnity or fee-for-service plan, the employer's employees pay a certain amount of their medical expenses up front—the deductible portion—and afterward the insurance company pays all or a majority of the balance. Under this plan, the employee has the right to choose doctors, hospitals and other health care providers. Within some limits, the employee can refer herself to any specialist without permission, and the insurance company must pay even it later determines the visit to the healthcare provider was not necessary. Typically, traditional indemnity or fee-for-service plans do not cover preventive care services—i.e., annual physicals—but as preventive care is gaining acceptance this is changing. The other form of group health insurance is managed care. Although there are three basic types of managed care plans, all involve an arrangement between the group health insurance provider and a selected network of health care providers. The employee is offered significant financial incentives to use the providers in the selected network. The first type of managed care plan is the PPO. PPOs make prior arrangements for lower fees with a network of health care providers. PPOs give their policyholders a financial incentive to use healthcare providers within the network in the form of reduced co-pay and higher percentage of the total bill paid by the group health insurer. Like the traditional indemnity plan, the employee may refer himself to a specialist without approval as long as the health care provider is within the network. Preventive services may not be covered under a PPO. The second type of managed care plan is the POS plan. POS plans are similar to PPOs, but a Primary Care Physician (“PCP”) acts like a gatekeeper between the employee and more specialized care. The employee must choose her PCP from among the POS plan's network of doctors. POS plans are known to cover some preventive care services, and, in some cases, even health improvement programs like workshops on nutrition and smoking cessation, and discounts at health clubs. The third type of managed care plan is the HMO. In exchange for a reduced or non-existent co-payment, low premiums and minimal paperwork, an HMO requires that you only see its doctors, and that you get a referral from your PCP before you see a specialist. An HMO may have central medical offices or clinics, or it may consist of a network of individual practices. The employee must see an HMO-approved physician or pay the entire cost of the visit himself. Specialty services and non-emergency hospital admissions require a specific referral or pre-authorization, respectively, from a HMO-approved PCP. HMOs routinely cover some or all of the cost of preventive care services and health improvement programs. All types of individual and group health insurance plans and their funding options all fall within the scope of the disclosure and claims herein.

In all of the embodiments of the invention, individuals, by themselves, or an employer on behalf of its employees, take the first step to contract with a health club, HWA, or HWIA as an individual or as a group, in the case of an employer, for access to the health club facilities. The individual or employer on behalf of his employees, join the health club, HWA, or HWIA as members with the understanding that the health club or association will either provide health insurance itself—if a HWIA—or will direct the individual or employer to one or more health insurance providers affiliated with the health club or HWA. The individuals and employers also understand that the health club facilities will be made available to them or their employees at reduced or no cost if they elect to obtain health insurance coverage through the health club, HWA or HWIA.

Financial benefits in becoming fit and maintaining fitness for individuals and employers arise from a combination of reduced or no cost access the health club facilities with reduced deductibles and/or premiums for health insurance as fitness improves. An individual or employer may also elect to pay the full cost of access to health club facilities in exchange for even lower deductibles and/or premiums for health insurance. Regardless of the option selected for payment of health club dues, overall costs for health club dues and health insurance deductibles and/or premiums for individuals and employers decrease as fitness improves.

The health club provides the facilities, the mental and physical health care professionals to monitor health and the systems and databases to track fitness via a predetermined, but flexible, series of health assessment indicators. These indicators may be, without limitation, age, sex, weight, height, body fat percentage, blood pressure, blood sugar, and lipid levels. Each selected health assessment indicator; e.g., age, sex, weight, health, etc., is given a weighting factor which is used to calculate a Personal Fitness Level (“PFL”). Each health insurance company affiliated with the health club or HWA informs the club or HWA which health assessment indicators and weighting to be used in calculating the PFL. The HWIA, by providing health insurance on its own, determines for itself the health assessment indicators and weighting for the PFL. The health assessment indicators are maintained, archived, and compiled by the health club. The calculation of the PFL may be performed manually or by a computer.

The PFL is a measure of fitness. For an employer, the PFL is aggregated over all employees. In other words, the employer's employees have one unique PFL that represents the fitness of all of that employer's employees at any given time. For the individual, the PFL represents that person's fitness. In the case of an individual, a man who is 60 years old and physically fit may have the same PFL as a 20 year old woman who is obese and suffers from diabetes. For an employer with say 300 employees, the PFL represents the aggregate fitness of his employees, some of whom may be in good health and others not.

The health club or HWA, by authorization included in the individual's or employer's contract, communicates the individual's or employer's aggregate PFL to one or more health insurance providers partnered with the health club or HWA. Using the PFL as a tool to gauge health insurance risk, the health insurance companies determine the deductible and premium options they are willing to offer the individual or employer, within the constraints of local laws and regulations governing individual and group health insurance plans. The available deductibles and premiums for health insurance are presumed to be based on the PFL. All individuals who have the same PFL are expected to be offered the same deductible and/or premium options for health insurance from any given health insurance provider for themselves and their dependents. Any employer whose employees have the same aggregate PFL as another employer are expected to be offered the same deductible and/or premium options for group health insurance for their employees and their dependents from any given health insurance provider. However, different health insurance companies are under no obligation to offer the same deductible and/or premium options as another insurance company for an individual or group of employees with the same PFL.

To maintain predictability and fairness in health insurance pricing within any given HWA or health club and their affiliated health insurance providers, the calculation of the PFL is set by agreement and may only be changed with notice. Health insurance companies and the HWIA will create groups defined by the PFL. For example, without limitation, the PFL may range from 1 to 9, with lower numbers representing better fitness. In this instance, the preferred risk group may be represented by those individuals or employer's employees with a PFL of 1-3. Mid-range higher insurance risk groups may be represented by PFLs with ranges of 4-6, and the highest risk, 7-9. The deductibles and/or premiums for health insurance from a particular health insurance provider for an individual or employer's employees with a PFL within a group will be the same. However, another health insurance provider is free to provide the same insurance to that person or employer at a different premium and/or deductible and may even have different ranges of PFLs for risk assessment and pricing of health insurance. But, for any one health insurance provider, the deductible and/or premium is the same for all persons with the same PFL.

On a regular basis, the HWIA or health insurance provider affiliated with the HWA or health club assesses the actual health insurance costs paid or incurred within each PFL. As the actual health care costs paid or incurred increases or decreases within a risk group defined by PFL, the HWIA or health insurance provider makes corresponding adjustments in its deductibles and/or premiums for that group. Over time, a person or employer with employees having a PFL within a particular risk group may experience lower health insurance deductibles and/or premiums if members in the same group reduce their health care costs. On the other hand, deductibles and/or premiums may increase if the health care costs rise for members within a risk group. In this case, the individual has the option of improving his health by additional health club visits or more vigorous exercise to achieve a more favorable PFL. The employer has the option of more aggressively promoting among employees the benefits of fitness with the goal of his employees attaining a more favorable aggregate PFL.

The system and method disclosed herein provides incentives to individuals or employees to routinely use health club facilities with the goal of a achieving a healthier individual as represented by a more favorable PFL. A more favorable PFL is one that a health insurance provider would recognize as qualifying a person or group for a lower deductible and/or premium for health insurance. The process of obtaining a more favorable PFL is iterative. As an individual takes advantage of the facilities and services of the health club, his PFL should improve. For the employer, as his employees improve their health through use of health club facilities, their aggregate PFL should become more favorable. The more favorable PFL qualifies the individual or employer for a combination of reduced or no cost health club dues and/or reduced deductibles and/or premiums for health insurance.

### BRIEF DESCRIPTION OF THE SEVERAL VIEWS OF THE DRAWINGS

### (1) Drawing Figures

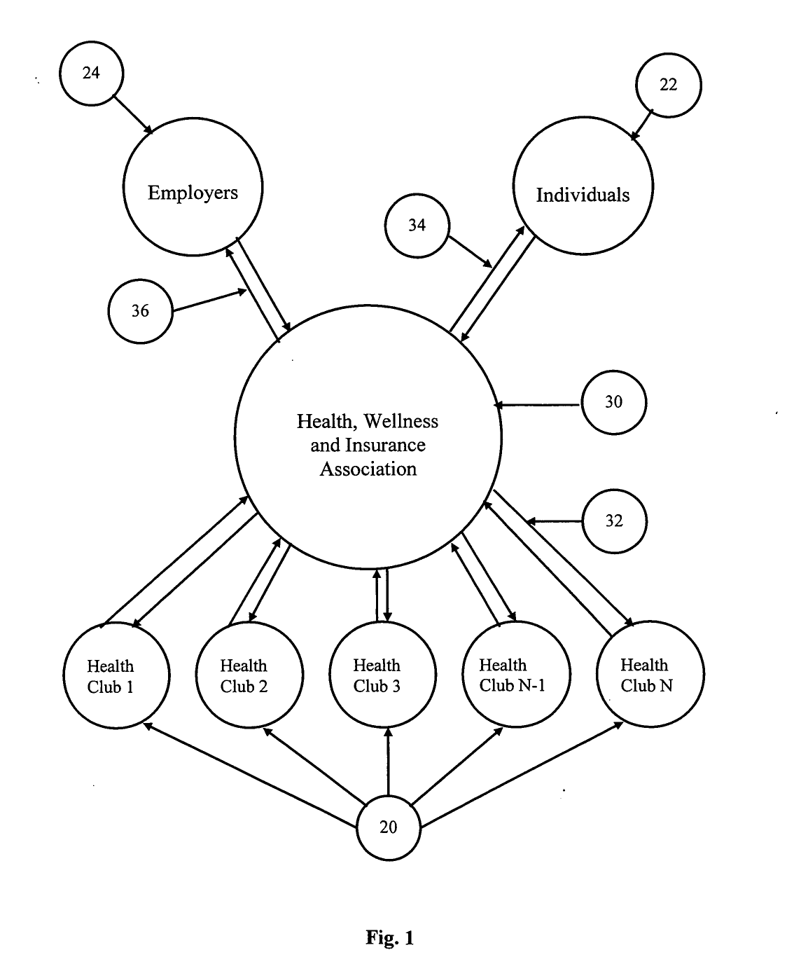

FIG. 1 is a flow chart illustrating the preferred embodiment of the invention. It shows a HWIA affiliated with a plurality of health clubs and providing health club services and health insurance to employers and individuals.

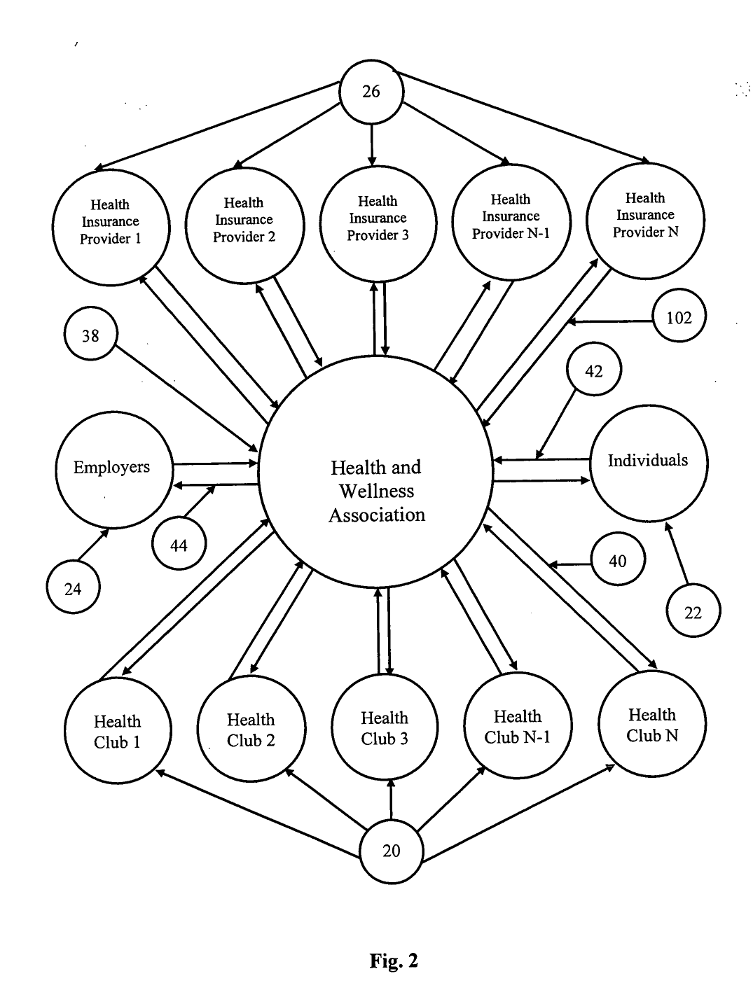

FIG. 2 is a flow chart illustrating the first alternate embodiment of the invention. It shows a HWA affiliated with a plurality of health clubs and a plurality of health insurance providers and providing health club services and access to health insurance providers to employers and individuals.

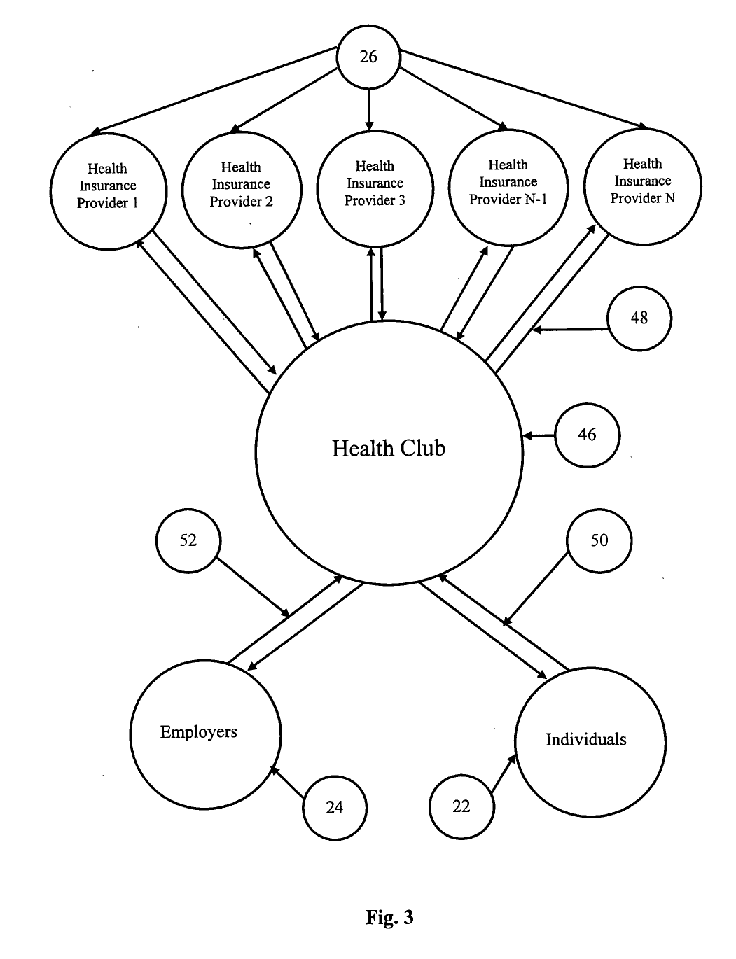

FIG. 3 is a flow chart illustrating the second alternate embodiment of the invention. It shows a single health club affiliated with a plurality of health insurance providers and providing health club services and access to health insurance providers to employers and individuals.

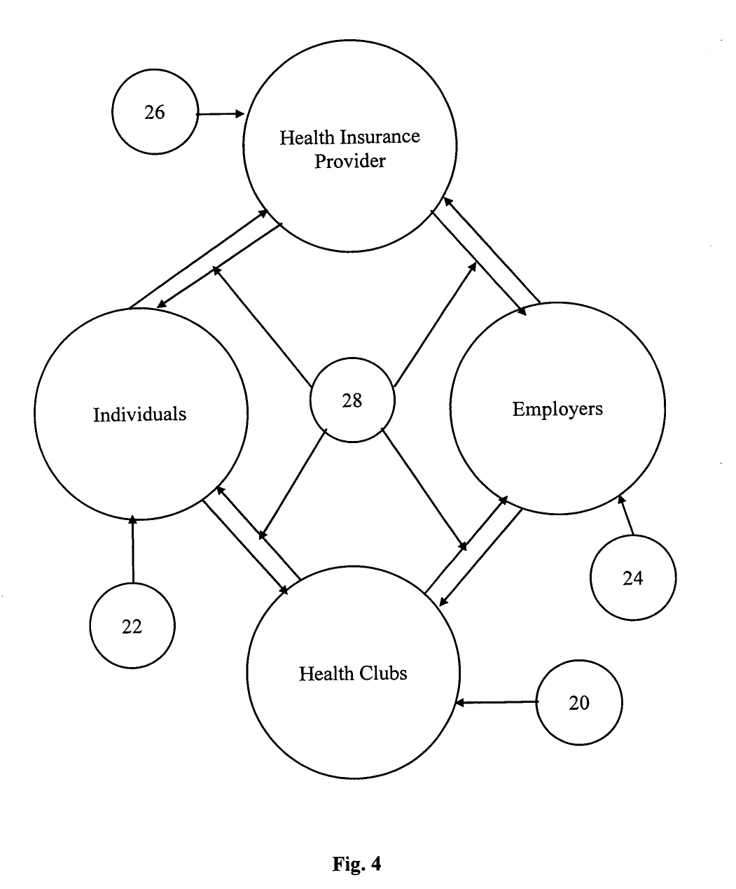

FIG. 4 is a flow chart illustrating the current relationships between an individual, employer, health club and health insurance provider.

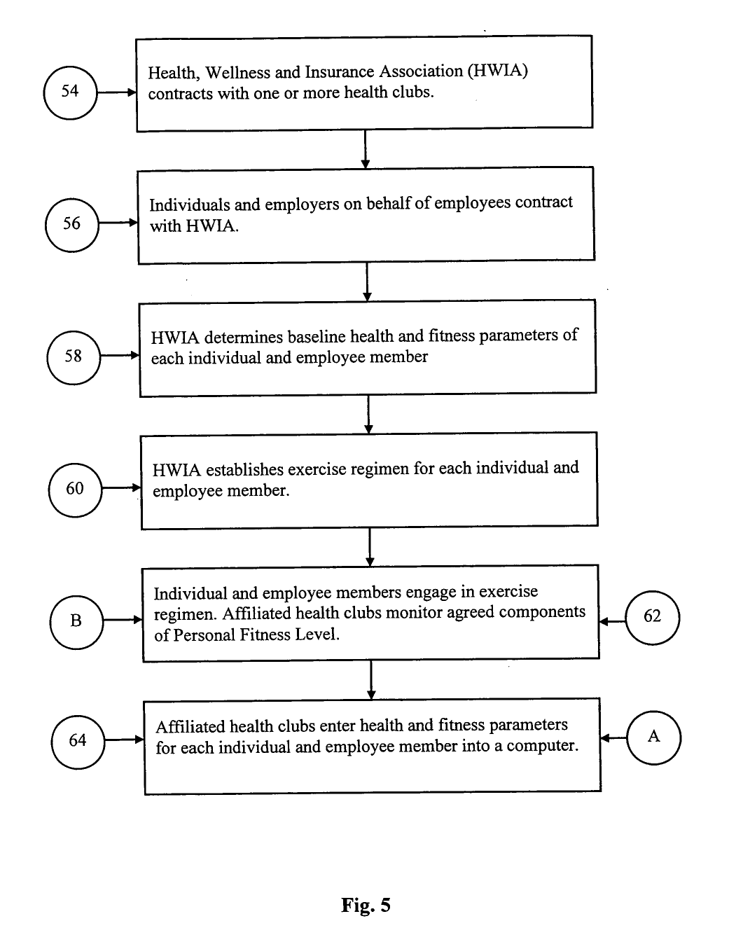

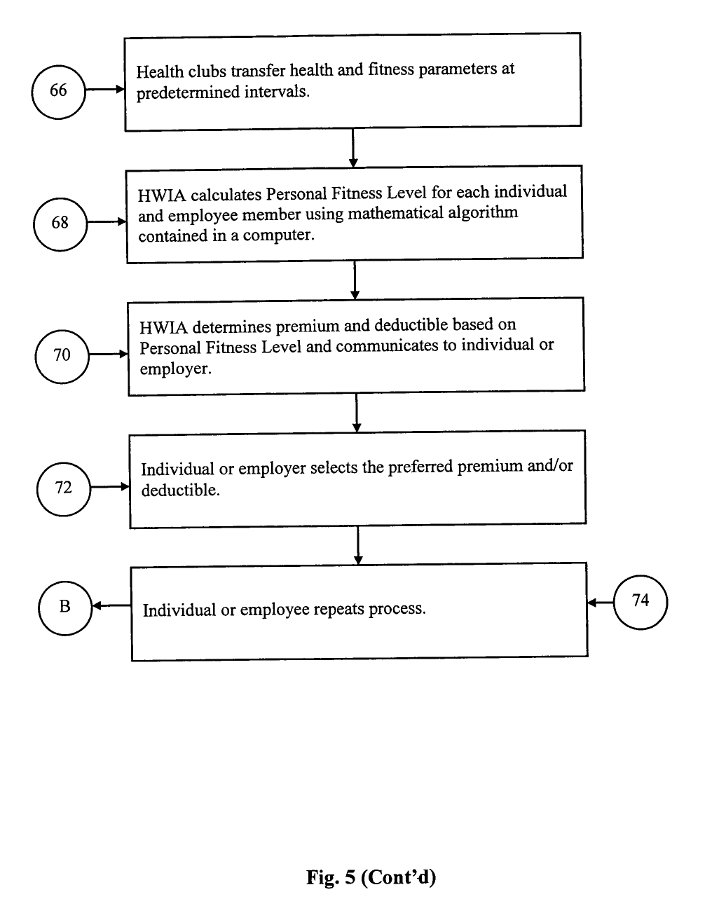

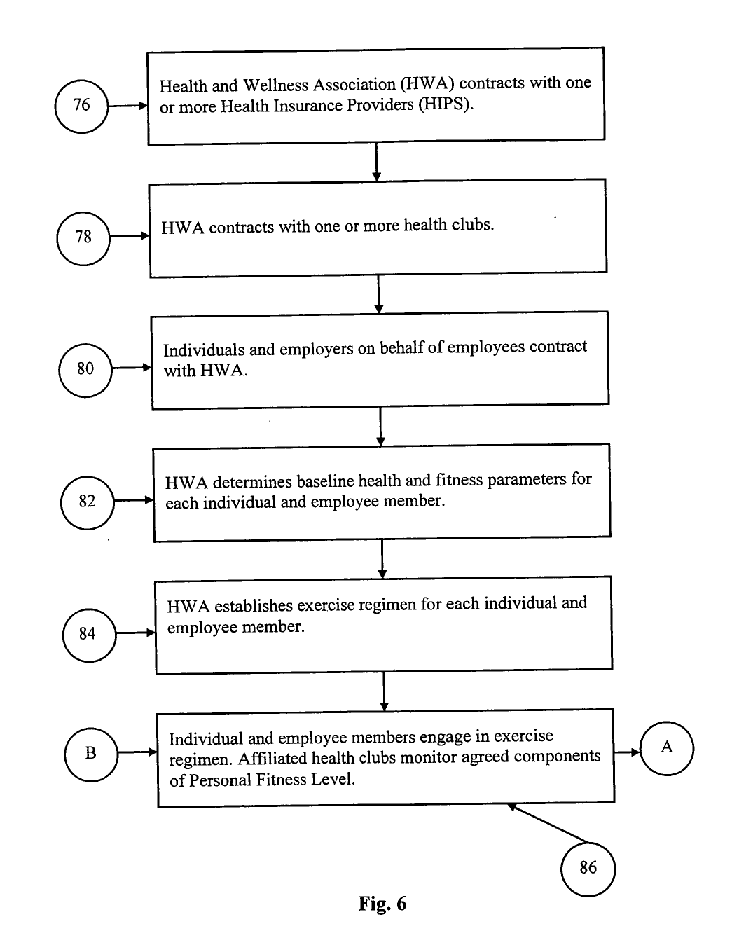

FIG. 5 is a flow chart depicting the fitness monitoring by a health club, calculation of the PFL by a HWIA, and determination of health club dues and health insurance premiums and deductibles.

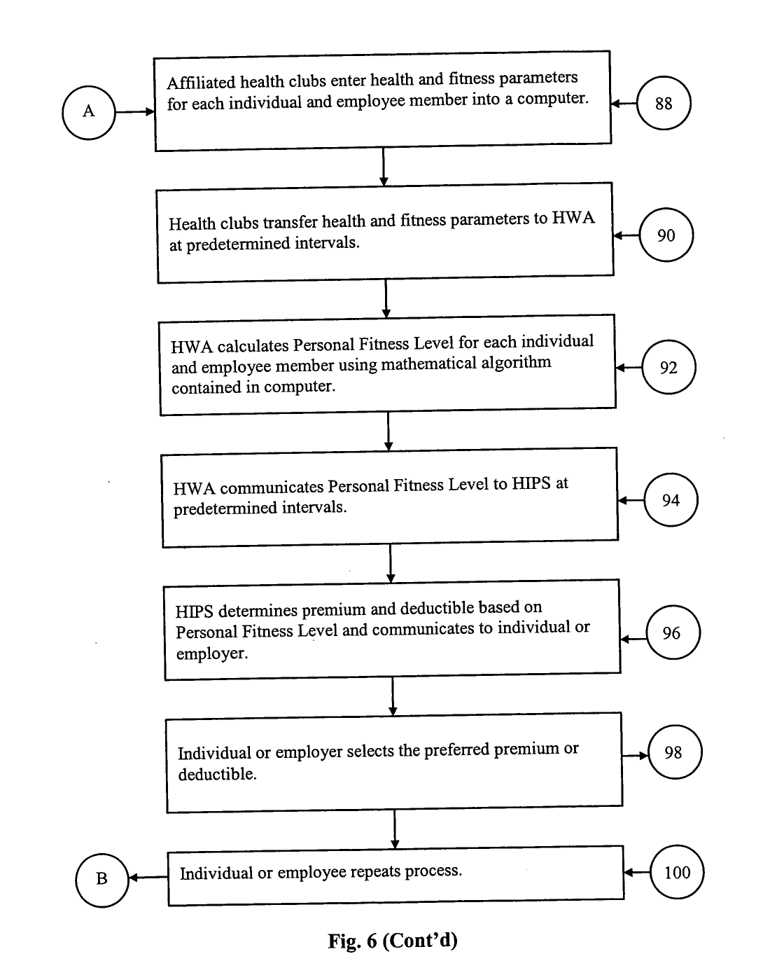

FIG. 6 is a flow chart depicting the fitness monitoring by a health club, calculation of the PFL by a HWA, and determination of health club dues and health insurance premiums and deductibles by health insurance providers.

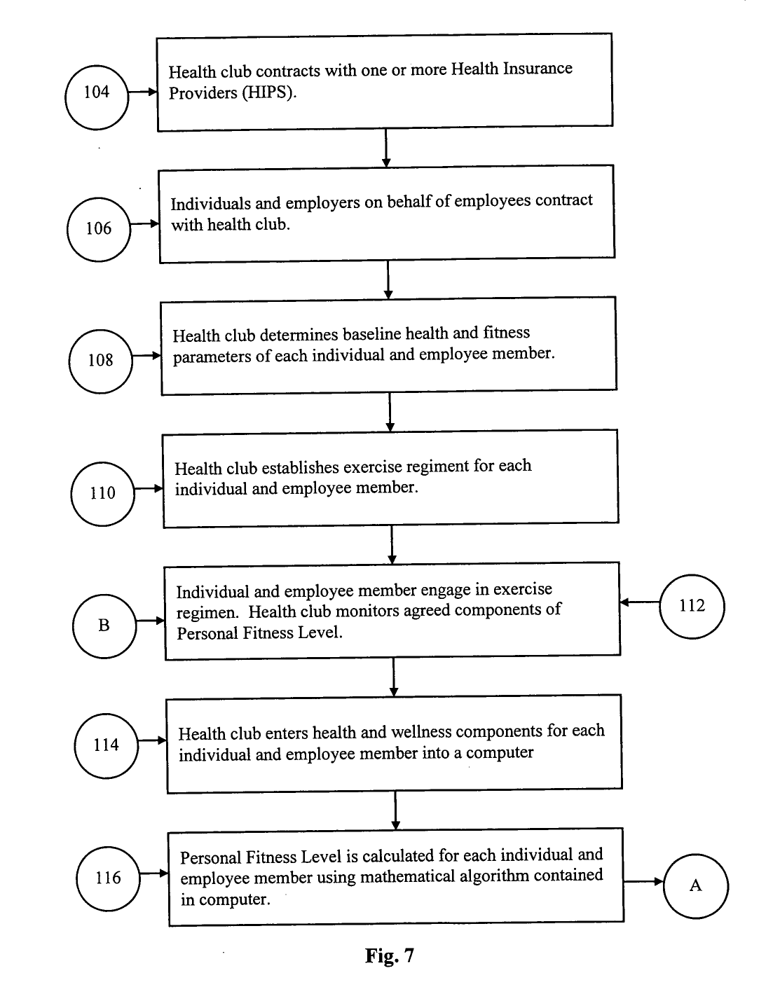

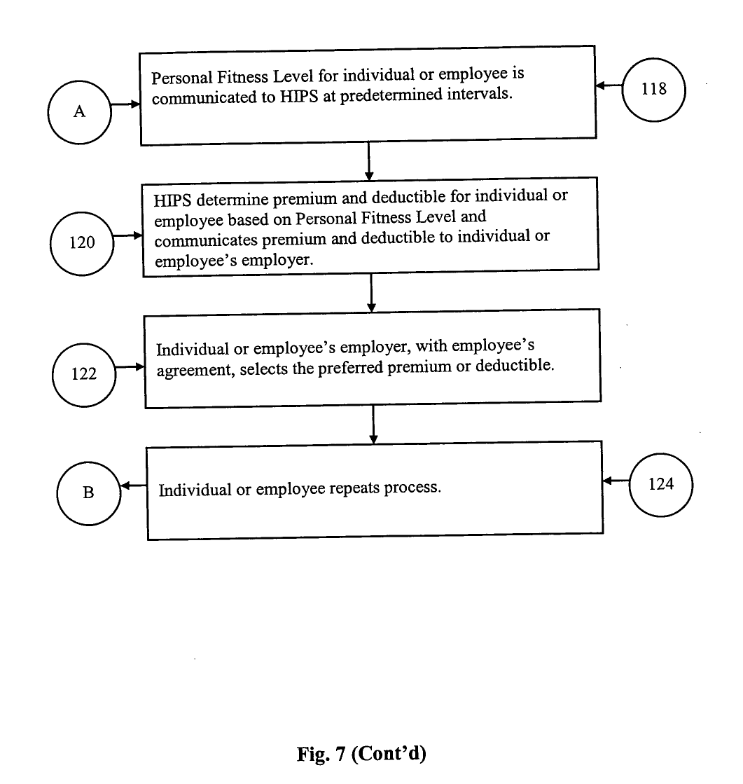

FIG. 7 is a flow chart depicting the fitness monitoring by a health club, calculation of the PFL by the health club, and determination of health club dues and health insurance premiums and deductibles by health insurance providers.

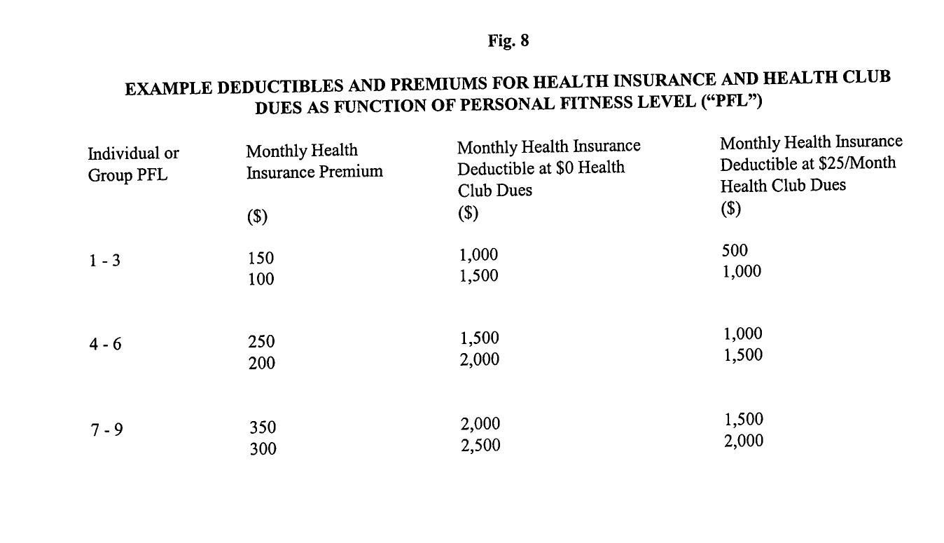

FIG. 8 shows an example of the pricing structure for a system in which health dues and health insurance deductibles and/or premiums for individuals or groups are integrated and determined based on PFL.

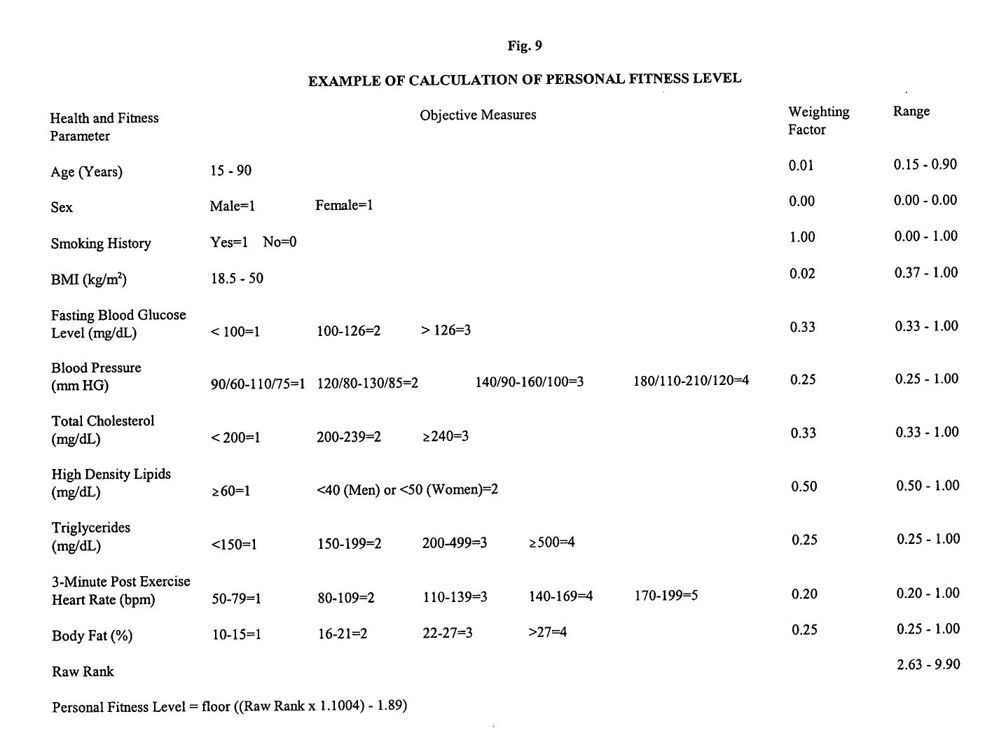

FIG. 9 depicts, by way of example, the calculation of PFL from a series of health assessment indicators.

### DETAILED DESCRIPTION OF THE EMBODIMENTS

FIG. 4 shows the current oral or written contractual relationships 28 between a health club 20, individual 22, employer 24, and health insurance provider 26. As shown in FIG. 4, there is no relationship between an individual's or an employer's health club and the health insurance provider. In the current well-ness and health insurance environment, an individual or employer may have an agreement with a health insurance provider to provide insurance for himself or the employer's employees and separate agreements with a health club for maintenance of well-ness. This invention transforms the relationships between individuals, employers on behalf of their employees, health clubs and health insurance providers with the goal of integrating personal fitness and access to health insurance to further transform individuals into more mentally and physically healthy beings.

### (1) Detailed Description of the Preferred Embodiment

In the preferred embodiment, a HWIA is created which provides access to affiliated health clubs, well-ness programs, management of health and fitness parameters, and health insurance to its individual members and the employees of its employer members. Referring to FIG. 1, the invention described herein is a system and method for promoting and improving the health of individuals 22 and employees of employers 24 by the regular monitoring of health and fitness parameters, previously determined by a HWIA 30. A plurality of health clubs 20 are affiliated via oral or written agreements 32 with the HWIA 30. Individuals 22 also have oral or written agreements 34 with the HWIA 30 which provide that for their membership they will have access to a plurality of health clubs 20 at reduced or no health club dues in which to maintain and improve their health and availability of health insurance at preferred premium and/or deductible rates provided by the HWIA 30. Employers 24 on behalf of their employees also have oral or written agreements 36 with the HWIA 30. Agreements 36 provide that the employer's 24 employees will have access to a plurality of health clubs 20 at reduced or no health club dues to maintain and improve their health and that the employer 24 will have access to health insurance at preferred premium and/or deductible rates for its employees.

### (2) Detailed Description of the First Alternate Embodiment

In the first alternate embodiment, a HWA is created which provides access to a plurality of affiliated health clubs, well-ness programs, management of health and fitness parameters, and access to a plurality of health insurance providers to its individual members and the employees of its employer members. Referring to FIG. 2, the invention described herein is a system and method for promoting and improving the health of individuals 22 and employees of employers 24 by the regular monitoring of health and fitness parameters, previously determined in concert by the HWA 38 and health insurance providers 26. One or more health clubs 20 are affiliated via oral or written agreements 40 with the HWA 38. Further, one or more health insurance providers 26 are also affiliated with the HWA 38 via oral or written agreements 102. Individuals 22 also have oral or written agreements 42 with the HWA 38 which provide that for their membership they will have access to a plurality of health clubs 20 at reduced or no cost health club dues in which to maintain and improve their health and have access to a plurality of health insurance providers 26 from which to obtain health insurance at preferred deductible and/or premium rates. Employers 24 on behalf of their employees also have oral or written agreements 44 with the HWA 38. Agreements 44 provide that the employer's 24 employees will have access to a plurality of health clubs 20 at reduced health club dues affiliated with HWA 38 to maintain and improve their health and that the employer 24 will have access to a plurality of health insurance providers 26 from which to obtain health insurance at preferred deductible and/or premium rates for its employees.

### (3) Detailed Description of the Second Alternate Embodiment

In the second alternate embodiment, a health club provides well-ness programs, management of health and fitness parameters, and access to a plurality of health insurance providers to its individual members and the employees of its employer members. Referring to FIG. 3, the invention described herein is a system and method for promoting and improving the health of individuals 22 and employees of employers 24 by the regular monitoring of health and fitness parameters, previously determined in concert by the health club 46 and health insurance providers 26. A plurality of health insurance providers 26 are affiliated via oral or written agreements 48 with the health club 46. Individuals 22 also have oral or written agreements 50 with the health club 46 which provide that for their membership at reduced or no cost health club dues they will have access to well-ness programs and management through the club's facilities and access to a plurality of health insurance providers 26 affiliated with health club 46. Employers 24 on behalf of their employees also have oral or written agreements 52 with the health club 46. The agreements 48 between the health club 46 and health insurance providers 26 provide that the health club 46 will provide its facilities at reduced or no cost health club dues and health insurance will be made available to the health club's 46 individual 22 members and employees of the employer members 24 at preferred premium and/or deductible rates.

### (4) Determining the Personal Fitness Level (“PFL”)

The health clubs, Items 20 in FIGS. 1 and 2, and Item 46 in FIG. 3, regardless of their affiliation with a HWIA 30, HWA 38 or acting alone 46, provide the individual 22 member or employer's 24 employees access to fitness equipment and health and well-ness programs and management. The health clubs, 20 and 46, also monitor the individual's or employee's health and fitness parameters as a means to achieve an objective assessment of total body fitness. By way of example and without limitation, the health and fitness parameters comprise height, weight, sex, age, blood pressure, blood sugar level, body fat composition, body mass index (“BMI”), lipid levels, muscle strength, abdominal strength, flexibility and smoking history. The fitness parameters are used by the health club, 20 or 46, to calculate a PFL. Health insurance companies 26 affiliated with HWA 38 or health clubs, 20 or 46, collaborate with the HWA or health clubs to determine the health and fitness parameters which will be monitored by the health clubs, 20 or 46, and how each will be weighted in the calculation of the PFL. A HWIA 30, because it provides health insurance in its own right, collaborates with the health clubs directly to determine the health and fitness parameters which will be monitored by the health clubs, 20 or 46, and how each will be weighted in the calculation of the PFL.

Depending on how calculated, the PFL may range from say 1 to 9. However, the invention is not limited to any particular low and high values for the PFL. Once the HWIA 30 or a health insurance company 26 decides on the health and fitness parameters and the weighting factors for each which comprise the PFL, the health club, 20 or 46, affiliated with the HWIA 30 or HWA 38 or health insurance company 26 will calculate the PFL in that manner.

The HWIA 30 or health insurance companies 26 have the flexibility to group the PFLs for determining available deductibles and/or premiums in each group according to their unique business requirements. For example, using a PFL which ranges from 1 to 9, Insurance Company 1 may decide that individuals or employer's employees with an individual or aggregate PFL of 1-3 are entitled to Deductible A and Premium B. Insurance Company 2 may decide that it is better served when individuals or employers' employees with an individual or aggregate PFL of 3-4 are entitled to the same deductible or premium offered by Insurance Company 1. Further, Insurance Company 3 may decide persons with PFLs of 1 to 3 are entitled to Deductible C and Premium D. However, no health insurance provider 26 may offer deductibles and/or premiums financially less favorable to an individual or employer who has a more favorable PFL, indicating a lower level of risk for the health insurance provider.

Once the HWIA 30, HWA 38 or health insurance providers 26 communicate to the health club, 20 or 46, the health and fitness parameters and the weighting factors for calculating their PFL, the health club provides the equipment, facilities and fitness consultants to improve the member's health and fitness. The health club, 20 or 46, uses its expertise in developing an exercise regimen that is recordable and verifiable and designed to maintain and/or improve the individual's or employee's health and fitness parameters. Examples of the exercise regimen contemplated herein include, without limitation, floor exercises, strength training and cardiovascular exercises. The associated health and well-ness program may include smoking cessation, weight control courses, nutrition and label education, and stress reduction. The effects of the exercise regimen on the individual's or employee's health are determined by periodic strength and flexibility measurements, physical examinations, blood and urine testing, testing of health and well-ness indicators, and other disease-indicating tests.

The flow chart in FIG. 5 depicts the system and method through which an individual or employer on behalf of his employees, obtains health insurance through a HWIA. Referring to FIGS. 1 and 5 in concert and beginning with Position 54 in FIG. 5, the HWIA 30, contracts 32, with one or more health clubs 20, to make facilities available to individuals 22, or employees of employers 24 for their health improvement program. In the next step, Position 56, individuals form contracts 34 or employers on behalf of their employees form contracts 36 with the HWIA 30 to obtain health insurance at preferred risk deductibles and/or premiums. The HWIA determines the baseline health and well-ness components for each individual and employee member, Position 58. In Position 60, the health club establishes the exercise regimen and health and well-ness improvement program—for example, smoking cessation or dietary education—for each individual and employee member.

Continuing to refer to FIG. 5, the individual and employee member engage in the exercise regimen and health and well-ness programs at one or more of the affiliated health clubs, Position 62. In Position 64, the health clubs monitor the health and well-ness components and enter the data into a database resident in a computer. As depicted in Position 66, the health and well-ness components for each individual or employee member are transferred to a central computer which is under the control of the HWIA. The central computer contains the mathematical algorithm which is used to calculate the PFL from the health and well-ness components, Position 68. In Position 70, the HWIA uses the PFL to determine various deductible and/or premium combinations available to the individual based on her PFL. For employees, the PFLs of an employer's applicable group are aggregated to create a PFL representing the group. In Position 72, periodically the individual or employer on behalf of his employees selects the desired deductible and/or premium. According to Position 74, the individual or employee repeats the process by continuing the exercise regimen, shown as Position 62.

FIGS. 2 and 6, when read together, show the system and method by which the HWA 38, individual and employee members, health insurance providers and health clubs are integrated to achieve reduced or no cost health club membership and preferred risk deductibles and/or premiums for health insurance. Referring to both FIGS. 2 and 6, in the first step, Position 76, HWA 38 establishes contracts 102 with one or more health insurance providers 26. In Position 78, the HWA 38 also enters into contracts with one or more health clubs 20 to allow access to their facilities for individual 22 and employer's 24 employees who are members of the HWA 38. Position 80 represents the step of individuals 22 and employer's 24 on behalf of their employees contracting 42 and 44 with the HWA 38 for health and well-ness and access to preferred risk health insurance.

Continuing to refer to FIGS. 2 and 6, in Position 82 the HWA 38 in concert with health insurance providers 26 determine the baseline health and well-ness components of each individual 22 and employer's 24 employees who are members of the HWA. In Positions 84 and 86 in FIG. 6, the health club establishes an exercise regimen and health and well-ness program for each individual and employee. The affiliated health clubs 20 agree to monitor and record the health and fitness components of the PFL. In Position 88, the health clubs 20 monitor the health and well-ness components and enter the data into a database resident in a computer. As depicted in Position 90, the health and well-ness components for each individual or employee member are transferred to a central computer which is under the control of the HWA. The central computer contains the mathematical algorithm which is used to calculate the PFL from the health and well-ness components, Position 92. In Position 94, the HWA communicates the individual PFL, or aggregate PFL for employers, to the affiliated health insurance providers to determine various deductible and/or premium combinations. The various preferred risk health insurance deductibles and/or premiums are communicated to the individual or employers to select the desired deductible and/or premium, Positions 96 and 98. According to Position 100, the individual or employee repeats the process by continuing the exercise regimen, shown as Position 86.

FIGS. 3 and 7, when read together, show the system and method by which a health club 46, its individual 22 and employer members 24, and health insurance providers 26 and the steps to achieve reduced or no cost health club dues and preferred risk deductibles and/or premiums for health insurance. Referring to both FIGS. 3 and 7, in the first step, Position 104, the health club 46 establishes contracts 48 with one or more health insurance providers 26. Position 106 represents the step of individuals 22 and employer's 24 on behalf of their employees contracting 50 and 52 with the health club 46 for health and well-ness and access to preferred risk health insurance offered by the health insurance providers 26.

Proceeding to refer to FIGS. 3 and 7, in Position 108 the health club 46 in concert with health insurance providers 26 determine the baseline health and well-ness components of each individual 22 and employer's 24 employees who are members of the health club. In Positions 110 and 112 in FIG. 7, the health club establishes an exercise regimen and health and well-ness program for each individual and employee and monitors and records the health and fitness components of the PFL. In Position 114, the health club enters the results of the health and fitness components into a database resident in a central computer. The central computer contains the mathematical algorithm which is used to calculate the PFL from the health and well-ness components, Position 116. The health club communicates the PFL to the affiliated health insurance providers 26 at predetermined intervals, Position 118. Continuing to refer to FIGS. 3 and 7, in Position 120 the health insurance providers determine various deductible and/or premium combinations available to the individual or employer based on the individual or aggregate PFL and communicates these to the individual or employer. The individual or employer selects the desired deductible and/or premium in Position 122. The individual or employee then repeats the process by continuing the exercise regimen, shown as Positions 116 and 124.

In all of the embodiments of the invention, the health club monitors the health and fitness parameters of the member as he participates in the exercise regimen. The monitoring of health and fitness data may be accumulated by any combination of manual or electronic data collection methods by one or more health club employees, sensors built into the exercise machines used by the member, heart rate or blood pressure monitoring devices worn by the member, pedometers or any other such devices known to those skilled in the human fitness arts. These data may be recorded manually in spreadsheets for later entry into a central computer or transmitted directly by hard-wire or wireless means to the central computer from the monitoring device on the exercise machine and/or from that worn by the user. The central computer can be continuously accessed by a health club employee to profile, track, and generate the data into a format useful for calculating the PFL.

The central computer contemplated in this invention comprises a man-machine interface for entering and retrieving data, a central processing unit, and memory sufficient to store the health and fitness parameter data for a plurality of individual or employer's employee members and to perform numerical manipulations to calculate, as a minimum, the PFL. The program codes and algorithms can be embodied in the form of computer processor usable media, such as floppy diskettes, CD-ROMS, zip drives, non-volatile memory, or any other computer-readable storage medium, wherein the computer program code is loaded into and executed by the central computer. Optionally, the program codes and/or operational algorithms of the subject invention can be programmed directly onto the CPU using any appropriate programming language, preferably C programming language.

The central computer may further include the necessary hardware and software to provide analyzed monitored information into an output form readily accessible by the insurance carrier, trained physician, technician, or insurance member. For example, without limitation, an audio device in conjunction with audio speakers can relay monitored and analysis results into an audio signal, and/or a graphical interface can display results in a graphical form on a monitor and/or printer. Further, the central computer can also include the necessary software and hardware to receive, route and transfer data to and from a remote location in which the portable device is in use.

By way of example, the PFL may range from 1 to 9 based on the health and fitness parameters comprising age, sex, systolic and diastolic blood pressure, fasting blood glucose level, lipid levels and smoking history. On this scale, a PFL of 1 represents a fit individual and 9 a person in a condition of extreme unfitness.

FIG. 9 shows an example of how the PFL, ranging from 1-9, would be determined from the health and fitness parameters of age, sex, smoking history; BMI, blood pressure, fasting blood glucose level, total cholesterol, high density lipids (“HDL”), triglycerides, 3-minute post exercise heart rate, and body fat. As shown in FIG. 9, typical ranges for objective measures of the various criteria are either used directly for measurement, such as age and BMI, assigned a representative value for calculation, such as blood pressure, body fat, and sex. For virtually all members, parameter ranges might be: age 15 to 90 years; sex male or female; smoking history yes or no; BMI 18.5 to 50 kg/m2; blood pressure 90/60 to 210/120 mm Hg; fasting blood glucose level <100 to >126 mg/dL; total cholesterol <200 to ≧240 mg/dL; high density lipids <40 to ≧60 mg/dL; triglycerides <150 to ≧500 mg/dL; 3-minute post exercise heart rate 50 to 199 bpm; body fat 10 to >27%. In the example shown in FIG. 9, weighting factors are assigned to each fitness parameter so that the maximum contribution to the PFL is 1.0 for that parameter. In FIG. 9, the weighting factors range from 0 to 1.

Continuing to refer to FIG. 9, the sums of the weighted fitness parameters are expressed as the Raw Rank and extend from 2.63 to 9.9. In this case, the Raw Rank may be normalized to a PFL of 1 to 9 by Equation 1:

PFL=floor((Raw Rank×1.1004)−1.89))

where floor (x) is the largest integer not greater than x. For Raw Rank of 2.63, PFL is 1 and for 9.9, the PFL is 9.

For the preferred embodiment, an individual contracting with the HWIA may have the following health and fitness parameters: age 50 years; sex male; smoking history yes; BMI 40 kg/m2; blood pressure 150/95 mm Hg; fasting blood glucose level 130 mg/dL; total cholesterol 220 mg/dL; high density lipids 30 mg/dL; triglycerides 300 mg/dL; 3-minute post exercise heart rate 150 bpm; body fat 25%. With these initial fitness parameters and weighting factors shown in FIG. 9, the Raw Rank is the sum of:

| | |
|---|---|
| Age | 0.50 |
| Sex | 0.00 |
| Smoking history | 1.00 |
| BMI | 0.80 |
| Blood Pressure | 0.75 |
| Fasting Blood Glucose Level | 1.00 |
| Total Cholesterol | 0.66 |
| High density lipids | 1.00 |
| Triglycerides | 0.75 |
| 3-minute post exercise heart rate | 0.80 |
| Body fat | 0.75 |
| Raw Rank | 7.01 |

Using Equation 1, the PFL is 5.

By way of example for an employer with N employees, the aggregate PFL may be calculated as an arithmetic average of the PFL for each employee according to Equation 2:

$$Aggregate PFL = {\sum }_{1}^{N} {PFL}_{n} / N$$

where PFLₙ is the PFL for a particular employee and N is the total number of employees. The invention described herein contemplates that any number of averaging techniques may be employed to arrive at the PFL which represents the overall health and fitness of an employer's employees.

Referring to FIG. 8 by way of example, an individual with a PFL of 5 is entitled to health club dues and health insurance deductibles and/or premiums for those persons or groups with PFLs of 4-6. Depending on the desired deductible, the individual may select health insurance with a monthly premium of $200 or $250. In this example, if the individual elects to HWIA to underwrite all health club dues the available deductibles are $1,500 or $2,000. However, if the same person determines that he may require health care in the near future, he may decide to pay monthly health club dues of $25 to obtain the lower health insurance deductibles of $1,000 or $1,500. The same benefits are available to the employees of an employer who is a member of the HWIA. In this case, the PFL is the aggregate of the employer's applicable employees. Regardless of the health of any particular employee, all employees are grouped together by aggregate PFL to determine available health insurance deductibles and/or premiums.

Referring to FIG. 5, the health club armed with the individual's fitness parameters and initial PFL, establishes an exercise regimen, Positions 58 and 60. In Positions 62-68, the individual uses the facilities and services of health clubs affiliated with the HWIA, fitness parameters are monitored, and PFL calculated. Assuming the health improves for the individual, his PFL may decrease to say 3. As shown in FIG. 5 Positions 70 and 72, the HWIA determines the new health insurance deductibles and/or premiums to which the individual may qualify. In FIG. 8, the individual qualifies for any health insurance deductibles and/or premiums shown for those persons with PFL 1-3. If the aggregate PFL for an employer's employees decreased from 5 to 3, that group of employees would be entitled to the same health insurance deductibles and/or premiums.

The same system and method apply to a HWA and health club which are affiliated with health insurance providers. In these cases, the insurance is provided by one of more health insurance providers associated with the HWA or health club, rather than by the HWIA itself.

The above embodiments have been given by way of example only. Further examples will occur to those of skill in the art without departing from the spirit of the invention.

We claim:

1. A method for providing health insurance and health club membership to an individual at reduced deductible or premium, or both, for said health insurance and reduced or no cost membership fee for said health club membership, comprising:
(a) forming a Health Wellness and Insurance Association;
(b) said Health Wellness and Insurance Association meeting all applicable state and federal regulatory requirements to permit it to provide health insurance to said individual;
(c) said Health Wellness and Insurance Association contracting with one or more health clubs to provide exercise equipment and facilities for use by the individual;
(d) the Health Wellness and Insurance Association determining a plurality of health and fitness parameters to objectively assess the health and fitness of the individual;
(e) the Health Wellness and Insurance Association communicating said plurality of health and fitness parameters to one or more of said health clubs;
(f) the health club establishing a health and fitness improvement program for the individual;
(g) the individual engaging in said health and fitness improvement program at any of the one or more health clubs;
(h) the health club monitoring and recording the plurality of health and fitness parameters for the individual on a periodic basis;
(i) the health club entering the health and fitness parameters for the individual into a health club computer located at the health club on said periodic basis;
(j) said health club computer connecting to a Health Wellness and Insurance Association computer located at the Health Wellness and Insurance Association;
(k) the health club computer transferring the health and fitness parameters to said Health Wellness and Insurance Association computer via hardwired or wireless communication protocols;
(l) the Health Wellness and Insurance Association computer calculating a Personal Fitness Level for the individual using a mathematical algorithm based on a weighted combination of the health and fitness parameters;
(m) the Health Wellness and Insurance Association determining said premium or said deductible, or both, for the individual's health insurance based on his or her Personal Fitness Level;
(n) the Health Wellness and Insurance Association determining said membership fee based on the Personal Fitness Level;
(o) the Health Wellness and Insurance Association communicating the premium or the deductible, or both, for health insurance to the individual;
(p) the Health Wellness and Insurance Association communicating the membership fee to the individual;
(q) the individual selecting the preferred combination of premium or deductible, or both, for health insurance and health club membership fee; and
(r) repeating elements (f) to (q);
whereby the individual's health and fitness continuously improves or is maintained with the financial incentive of reduced premium or deductible, or both, for health insurance and health club membership at reduced or no cost.

2. A method for providing group health insurance and group health club membership to an employer, on behalf of employees, at reduced deductible or premium, or both, for said group health insurance and reduced or no cost membership fee for said group health club membership, comprising:
(a) forming a Health Wellness and Insurance Association;
(b) said Health Wellness and Insurance Association meeting all applicable state and federal regulatory requirements to permit it to provide health insurance to said employer;
(c) said Health Wellness and Insurance Association contracting with one or more health clubs to provide exercise equipment and facilities for use by said employer's employees;
(d) the Health Wellness and Insurance Association contracting with the employer to provide group health insurance to the employer's employees;
(e) the Health Wellness and Insurance Association determining a plurality of health and fitness parameters to objectively assess the health and fitness of each of employer's employee;
(f) the Health Wellness and Insurance Association communicating said plurality of health and fitness parameters to one or more of said health clubs;
(g) the health club establishing a health and fitness improvement program for each of employer's employees;
(h) the employer's employee engaging in said health and fitness improvement program at any of the one or more health clubs;
(i) the health club monitoring the plurality of health and fitness parameters for each of employer's employees on a periodic basis;
(j) the health club entering the plurality of health and fitness parameters for each employer's employee into a health club computer located at the health club on said periodic basis;
(k) said health club computer connecting to a Health Wellness and Insurance Association computer located at the Health Wellness and Insurance Association;
(l) the health club computer transferring the plurality of health and fitness parameters to said Health Wellness and Insurance Association computer via hardwired or wireless communication protocols;
(m) the Health Wellness and Insurance Association computer calculating a Personal Fitness Level for each employer's employee using a mathematical algorithm based on a weighted combination of the plurality of health and fitness parameters;
(n) the Health Wellness and Insurance Association computer averaging the Personal Fitness Level for each employer's employee to result in an aggregate Personal Fitness Level to represent all of the employer's employees;
(o) the Health Wellness and Insurance Association determining said premium or said deductible, or both, for the employer's group health insurance based on said aggregate Personal Fitness Level;
(p) the Health Wellness and Insurance Association determining said group health club membership fee based on the aggregate Personal Fitness Level;
(q) the Health Wellness and Insurance Association communicating the premium or the deductible, or both, for group health insurance to the employer;
(r) the Health Wellness and Insurance Association communicating the group health club membership fee to the employer;
(s) the employer, on behalf of employees, selecting the preferred combination of premium or deductible, or both, for group health insurance and group health club membership fee; and
(t) repeating elements (g) to (s);
whereby the employer's employee's health and fitness continuously improves or is maintained with the financial incentive of reduced premium or deductible, or both, for group health insurance and group health club membership at reduced or no cost.

3. A method for providing health insurance and health club membership to an individual at reduced premium or deductible, or both, for said health insurance and reduced or no cost membership fee for said health club membership, comprising:
(a) forming a Health and Wellness Association;
(b) said Health and Wellness Association meeting all applicable state and federal regulatory requirements to permit it to act as an agent for health insurance providers;
(c) the Health and Wellness Association contracting with one or more of said health insurance providers to provide health insurance to said individual;
(d) the Health and Wellness Association contracting with one or more health clubs to provide exercise equipment and facilities for use by the individual;
(e) the Health and Wellness Association contracting with the individual to provide access to one or more health clubs and to represent the individual before one of more health insurance providers;
(f) the Health and Wellness Association determining a plurality of health and fitness parameters to objectively assess the health and fitness of the individual;
(f) the Health and Wellness Association communicating said plurality of health and fitness parameters to one or more of said health clubs;
(g) the health club establishing a health and fitness improvement program for the individual;
(h) the individual engaging in said health and fitness improvement program at any of the one or more health clubs;
(i) the health club monitoring and recording the health and fitness parameters for the individual on a periodic basis;
(j) the health club entering the health and fitness parameters for the individual into a health club computer located at the health club on said periodic basis;
(k) said health club computer connecting to a Health and Wellness Association computer located at the Health and Wellness Association;
(l) the health club computer transferring the health and fitness parameters to said Health and Wellness Association computer via hardwired or wireless communication protocols;
(m) the Health and Wellness Association computer calculating a Personal Fitness Level for the individual using a mathematical algorithm in the computer based on a weighted combination of the health and fitness parameters;
(n) the Health and Wellness Association computer connecting to a health insurance provider computer at one or more of said health insurance providers;
(o) the Health and Wellness Association computer transferring said Personal Fitness Level to said health insurance provider computer;
(p) the health insurance provider determining said premium or said deductible, or both, for health insurance based on the Personal Fitness Level;
(q) the Health Wellness Association determining said membership fee based on the Personal Fitness Level;
(r) the health insurance provider communicating the premium or deductible, or both, to the Health and Wellness Association;
(s) the Health and Wellness Association communicating the premium or deductible, or both, for health insurance to the individual;
(t) the Health and Wellness Association communicating the membership fee to the individual;
(u) the individual selecting the preferred combination of premium or deductible, or both, for health insurance and health club membership fee; and
(v) repeating elements (g) to (r);
whereby the individual's health and fitness continuously improves or is maintained with the financial incentive of reduced premium or deductible, or both, for health insurance and health club membership at reduced or no cost.

4. A method for providing group health insurance and group health club membership to an employer, on behalf of employees, at reduced premium or deductible, or both, for said group health insurance and reduced or no cost membership fee for said group health club membership, comprising:
(a) forming a Health and Wellness Association;
(b) said Health and Wellness Association meeting all applicable state and federal regulatory requirements to permit it to act as an agent for group health insurance providers;
(c) the Health and Wellness Association contracting with one or more of said health insurance providers to provide group health insurance to said employer;
(d) the Health and Wellness Association contracting with one or more health clubs to provide exercise equipment and facilities for use by the employer's employees;
(e) the Health and Wellness Association contracting with the employer to provide access to one or more health clubs and to represent the employer before one or more group health insurance providers;
(f) the Health and Wellness Association determining a plurality of health and fitness parameters to objectively assess the health and fitness of each of employer's employees;
(g) the Health and Wellness Association communicating said plurality of health and fitness parameters to one or more of said health clubs;
(h) the health club establishing a health and fitness improvement program for each of employer's employees;
(i) the employer's employee engaging in said health and fitness improvement program at any of the one or more health clubs;
(j) the health club monitoring and recording the health and fitness parameters for each of employer's employees on a periodic basis;
(k) the health club entering the health and fitness parameters for each of employer's employees into a health club computer located at the health club on said periodic basis;
(l) said health club computer connecting to a Health and Wellness Association computer located at the Health and Wellness Association;
(m) the health club computer transferring the health and fitness parameters to said Health and Wellness Association computer via hardwired or wireless communication protocols;
(n) the Health and Wellness Association computer calculating a Personal Fitness Level for each of employer's employees using a mathematical algorithm in the computer based on a weighted combination of the health and fitness parameters;
(o) the Health Wellness and Insurance Association computer averaging the Personal Fitness Level for each of employer's employees to result in an aggregate Personal Fitness Level to represent all of the employer's employees;
(p) the Health and Wellness Association computer connecting to a health insurance provider computer at one or more of said health insurance providers;
(q) the Health and Wellness Association computer transferring said aggregate Personal Fitness Level to said health insurance provider computer;
(r) the group health insurance provider determining said premium or said deductible, or both, for group health insurance based on the aggregate Personal Fitness Level;
(s) the Health Wellness Association determining said group membership fee based on the aggregate Personal Fitness Level;
(t) the health insurance provider communicating the premium or deductible, or both, to the Health and Wellness Association;
(u) the Health and Wellness Association communicating the premium or deductible, or both, for group health insurance to the employer;
(v) the Health and Wellness Association communicating the group membership fee to the employer;
(w) the employer selecting the preferred combination of premium or deductible, or both, for group health insurance and group health club membership fee; and
(x) repeating elements (f) to (v);
whereby the employer's employee's health and fitness continuously improves or is maintained with the financial incentive of reduced premium or deductible, or both, for group health insurance and group health club membership at reduced or no cost.

5. A method for providing health insurance and health club membership to an individual at reduced premium or deductible, or both, for said health insurance and reduced or no cost membership fee for said health club membership, comprising:
(a) a health club meeting all applicable state and federal regulatory requirements to permit it to act as an agent for health insurance providers;
(b) said health club contracting with one or more of said health insurance providers to provide health insurance to said individual;
(c) the health club contracting with the individual to provide access to its facilities and to represent the individual before one of more health insurance providers;
(d) the health club determining a plurality of health and fitness parameters to objectively assess the health and fitness of the individual;
(e) the health club establishing a health and fitness improvement program for the individual;
(f) the individual engaging in said health and fitness improvement program at the health club;
(g) the health club monitoring and recording the health and fitness parameters for the individual on a periodic basis;
(h) the health club entering the health and fitness parameters for the individual into a health club computer located at the health club on said periodic basis;
(i) the health club computer calculating a Personal Fitness Level for the individual using a mathematical algorithm in the computer based on a weighted combination of the health and fitness parameters;
(j) the health club computer connecting to a health insurance provider computer at one or more of said health insurance providers;
(k) the health club computer transferring said Personal Fitness Level to said health insurance provider computer;
(l) the health insurance provider determining said premium or said deductible, or both, for health insurance based on the Personal Fitness Level;
(m) the health club determining said membership fee based on the Personal Fitness Level;
(n) the health insurance provider communicating the premium or deductible, or both, to the health club;
(o) the health club communicating the premium or deductible, or both, for health insurance to the individual;
(p) the health club communicating the membership fee to the individual;
(q) the individual selecting the preferred combination of premium or deductible, or both, for health insurance and health club membership fee; and
(r) repeating elements (c) to (q);
whereby the individual's health and fitness continuously improves or is maintained with the financial incentive of reduced premium or deductible, or both, for health insurance and health club membership at reduced or no cost.

6. A method for providing group health insurance and group health club membership to an employer, on behalf of employees, at reduced premium or deductible, or both, for said group health insurance and reduced or no cost membership fee for said group health club membership, comprising:
(a) a health club meeting all applicable state and federal regulatory requirements to permit it to act as an agent for group health insurance providers;
(b) said health club contracting with one or more of said health insurance providers to provide group health insurance to said employer;
(c) the health club contracting with the employer to provide its employees access to its facilities and to represent the employer before one or more group health insurance providers;
(d) the health club determining a plurality of health and fitness parameters to objectively assess the health and fitness of each of employer's employees;
(e) the health club establishing a health and fitness improvement program for each of employer's employees;
(f) the employer's employee engaging in said health and fitness improvement program at the health club;
(g) the health club monitoring and recording the health and fitness parameters for each of employer's employees on a periodic basis;
(h) the health club entering the health and fitness parameters for each of employer's employees into a health club computer located at the health club on said periodic basis;
(i) the health club computer calculating a Personal Fitness Level for each of employer's employees using a mathematical algorithm in the computer based on a weighted combination of the health and fitness parameters;
(j) the health club computer averaging the Personal Fitness Level for each of employer's employees to result in an aggregate Personal Fitness Level to represent all of the employer's employees;
(k) the health club computer connecting to a health insurance provider computer at one or more of said health insurance providers;
(l) the health club computer transferring said aggregate Personal Fitness Level to said health insurance provider computer;
(m) the group health insurance provider determining said premium or said deductible, or both, for group health insurance based on the aggregate Personal Fitness Level;
(n) the health club determining said group membership fee based on the aggregate Personal Fitness Level;
(o) the health insurance provider communicating the premium or deductible, or both, to the health club;
(p) the health club communicating the premium or deductible, or both, for group health insurance to the employer;
(q) the health club communicating the group membership fee to the employer;
(r) the employer selecting the preferred combination of premium or deductible, or both, for group health insurance and group health club membership fee; and
(s) repeating elements (c) to (r);
whereby the employer's employee's health and fitness continuously improves or is maintained with the financial incentive of reduced premium or deductible, or both, for group health insurance and group health club membership at reduced or no cost.

7. A system for providing health insurance and health club membership to an individual at reduced deductible or premium, or both, for said health insurance and reduced or no cost membership fee for said health club membership, comprising:
(a) a means for monitoring by one or more health clubs under contract to a Health Wellness and Insurance Association a plurality of health and fitness parameters which objectively represent the health and fitness of said individual;
(b) one or more health clubs providing equipment and facilities for the use by the individual to engage in health and fitness improvement and maintenance on a regular interval;
(c) a health club computer located at each of said one of more health clubs in which said health and fitness parameters for the individual are entered and stored;
(d) a Health Wellness and Insurance Association computer located at the Health Wellness and Insurance Association;
(e) a means for periodically transferring the health and fitness parameters for the individual from one or more health club computers to said Health Wellness and Insurance Association computer;
(f) the Health Wellness and Insurance Association computer programmed with a means for calculating a Personal Fitness Level for the individual using a mathematical algorithm based on a weighted combination of the health and fitness parameters;
(g) the Health Wellness and Insurance Association determining said premium or said deductible, or both, for the individual's health insurance based on his or her Personal Fitness Level;
(h) the Health Wellness and Insurance Association determining said membership fee based on the Personal Fitness Level;
(i) the Health Wellness and Insurance Association communicating the premium or the deductible, or both, for health insurance to the individual;
(j) the Health Wellness and Insurance Association communicating the membership fee to the individual;
(k) the individual selecting the preferred combination of premium or deductible, or both, for health insurance and health club membership fee; and
(l) repeating elements (a) to (k);
whereby the individual's health and fitness continuously improves or is maintained with the financial incentive of reduced premium or deductible, or both, for health insurance and health club membership at reduced or no cost.

8. A system for providing group health insurance and group health club membership to an employer, on behalf of employees, at reduced deductible or premium, or both, for said group health insurance and reduced or no cost membership fee for said group health club membership, comprising:
(a) a means for monitoring by one or more health clubs under contract to a Health Wellness and Insurance Association a plurality of health and fitness parameters which objectively represent the health and fitness of said employer's employees;
(b) one or more health clubs providing equipment and facilities for the use by the employer's employees to engage in health and fitness improvement and maintenance on a regular interval;
(c) a health club computer located at each of said one of more health clubs in which said health and fitness parameters for each of employer's employees are entered and stored;
(d) a Health Wellness and Insurance Association computer located at the Health Wellness and Insurance Association;
(e) a means for periodically transferring the health and fitness parameters for each of employer's employees from one or more health club computers to said Health Wellness and Insurance Association computer;
(f) the Health Wellness and Insurance Association computer programmed with a means for calculating a Personal Fitness Level for each of employer's employees using a mathematical algorithm based on a weighted combination of the health and fitness parameters which represents the health and fitness of the employee;
(g) the Health Wellness and Insurance Association computer averaging the Personal Fitness Level for each employer's employee to result in an aggregate Personal Fitness Level to represent all of the employer's employees;
(h) the Health Wellness and Insurance Association determining said premium or said deductible, or both, for the employer's group health insurance based on said aggregate Personal Fitness Level;
(i) the Health Wellness and Insurance Association determining said group health club membership fee based on the aggregate Personal Fitness Level;
(j) the Health Wellness and Insurance Association communicating the premium or the deductible, or both, for health insurance to the employer;
(k) the Health Wellness and Insurance Association communicating the membership fee to the employer;
(l) the employer, on behalf of employees, selecting the preferred combination of premium or deductible, or both, for group health insurance and group health club membership fee; and
(m) repeating elements (a) to (l);
whereby the employer's employee's health and fitness continuously improves or is maintained with the financial incentive of reduced premium or deductible, or both, for group health insurance and group health club membership at reduced or no cost.

9. The method in claim 1, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.

10. The method in claim 2, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.

11. The method in claim 3, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.

12. The method in claim 4, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.

13. The method in claim 5, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.

14. The method in claim 6, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.

15. The method in claim 7, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.

16. The method in claim 8, wherein the Personal Fitness Level is calculated from a weighted average of a group of health and fitness parameters comprising age, sex, smoking history, BMI, blood pressure, fasting blood glucose level, total cholesterol, high density lipids, triglycerides, 3-minute post exercise heart rate, and body fat.
